(19) United States
(12) Patent Application Publication
(10) Pub. No.: US 2011/0281071 A1
(43) Pub. Date: Nov. 17, 2011

(54) PROCESS FOR INCORPORATING CARBON PARTICLES INTO A POLYURETHANE SURFACE LAYER

(75) Inventor: Stephanie Vogel, Langenfeld (DE)

(73) Assignee: Bayer MaterialScience AG, Leverkusen (DE)

(21) Appl. No.: 13/146,790

(22) PCT Filed: Jan. 16, 2010
(86) PCT No.: PCT/EP10/00220

§ 371 Date: Aug. 5, 2011

(30) Foreign Application Priority Data
Jan. 30, 2009 (EP) 09001308.7

(51) Int. Cl. B05D 5/12; H01B 1/24; B82Y 30/00; B82Y 40/00

(52) U.S. Cl. 428/143; 427/122; 427/601; 977/750; 977/752; 977/742; 977/734; 977/842; 977/932

(57) ABSTRACT

The invention relates to a method for introducing electrically conductive carbon particles into a surface layer comprising polyurethane. These carbon particles can in particular be carbon nanotubes. In the method according to the invention, a solution of non-aggregated carbon particles having a mean particle diameter of from 0.3 nm to 3000 nm acts in a solvent upon a surface layer comprising polyurethane. The solvent is able to cause the maceration of a surface layer comprising polyurethane. The dwell time is measured such that it is not sufficient to carry the polyurethane over into the solution. The invention furthermore relates to a polyurethane layer that comprises electrically conductive carbon particles and can be obtained by means of a method according to the invention. The invention likewise relates to a polyurethane object having surface layer comprising electrically conductive carbon particles, obtainable by a method according to the invention.

The present invention relates to a process for incorporating electrically conductive carbon particles into a surface layer containing polyurethane. In particular these carbon particles can be carbon nanotubes. It also relates to a polyurethane layer which contains electrically conductive carbon particles and which can be obtained by a process according to the invention. The invention also relates to a polyurethane object having a surface layer obtainable by a process according to the invention and containing electrically conductive carbon particles.

Carbon nanotubes (CNTs) are known for their exceptional properties. For instance, their strength is roughly 100 times that of steel, their thermal conductivity is around twice that of diamond, their thermal stability is up to 2800° C. under vacuum and their electrical conductivity can be many times that of copper. At a molecular level, however, these structure-related characteristics are only accessible if the carbon nanotubes can be homogeneously distributed and the greatest possible contact established between the tubes and the medium, in other words by making them compatible and hence stably dispersible with the medium. With regard to electrical conductivity it is also necessary to form a homogeneous network of tubes in which ideally they are in contact only at the ends. The carbon nanotubes should be as separate as possible, i.e. free from agglomerates, not oriented and in a concentration in which a network of this type can just form, this being reflected by the abrupt rise in electrical conductivity as a function of the concentration of carbon nanotubes (percolation limit).

The incorporation of such particles into polymer matrices is thus of interest for technical applications. Two aspects have to be taken into consideration for a successful processing of carbon nanotubes, if the purpose of their use is to make a material electrically conductive, for example: carbon nanotube agglomerates have to be broken up and debunched completely, and the strong tendency of carbon nanotubes to reagglomerate (in the same medium during the ageing process or during processing of such a dispersion to form the finished material) has to be suppressed. These difficulties in carbon nanotube processing are based on the hydrophobic character of the carbon nanotube surface and the high aspect ratio of this quasi-one-dimensional structure.

If carbon nanotubes are to be prevented from finding an energy minimum in the form of bundles and/or agglomerates, their compatibility with the medium surrounding them must be increased. It should be noted that a chemical, covalent functionalisation of carbon nanotubes can improve their compatibility with the medium. This is expressed, for example, by an increased (thermal) long-term stability and the absence of reagglomeration during polyurethane production for example. However, this surface modification also interrupts the delocalised π-electron system of the tubes and thus lowers the electrical conductivity of each individual tube according to the degree of functionalisation.

The non-covalent functionalisation of carbon nanotubes, by means of dispersion additives for example, is an alternative to the chemical, covalent modification and compatibilisation of the tube with the medium. It should be noted, however, that this approach has to be optimised again for each new medium, whether polyurethane raw material or formulation, in terms of the chemistry and the concentration of the dispersion additive and can never represent a universal solution.

Finally it should be noted that whenever fillers—and hence also carbon nanotubes—are processed, there is a risk that although a new property may be obtained, for example electrical conductivity, at the same time several other mechanical properties may be reduced. This is especially critical when carbon nanotubes are incorporated into unfoamed, compact and/or flexible systems. In a compact moulding, for example, residual agglomerates which could not be completely broken up during the dispersion process represent a predetermined breaking point. Mechanical properties such as impact resistance and fracture resistance are reduced by such agglomerates. According to the prior art, in order to make a compact material electrically conductive by adding carbon nanotubes, the carbon nanotubes would have to be homogeneously distributed throughout the entire volume of the material such that the percolation limit is exceeded and at the same time no more residual agglomerates remain.

This procedure very often fails simply because of the dramatic rises in viscosity engendered by the concentrations of carbon nanotubes which are necessary in order to exceed the percolation limit. Furthermore, the reagglomeration of homogeneously dispersed carbon nanotubes during polyurethane processing cannot be excluded and directly prevented with this method.

In connection with the processing of carbon nanotubes in (thermoplastic) polyurethanes, numerous works are known from the literature in which the finished polymer is first completely dissolved in an organic solvent, then the nanotubes are dispersed in this polymer solution and the polyurethane-/solvent-based nanotube dispersion thus obtained is then drawn into a film or poured into a mould. The last step in these processes is the laborious evaporation of large amounts of solvent. Examples hereof can be found in the following publications: N. G. Sahoo, Y. C. Jung, H. J. Yoo, J. W. Cho, Composites Science and Technology 2007, 76, 1920-1929; N. G. Sahoo, Y. C. Jung, H. J. Yoo, J. W. Cho, Macromol. Chem. Phys. 2006, 207, 1773-1780; M. Xu, T. Zhang, B. Gu, J. Wu, Q. Chen Macromolecules 2006, 39, 3540-3545; J. Deng, J. Cao, J. Li, H. Tan, Q. Zhang, Q. Fu, Journal of Applied Polymer Science 2008, 108, 2023-2028; R. N. Jana, J. W. Cho Journal of Applied Polymer Science 2008, 108, 2857-2864 and X. Wang, Z. Du, C. Zhang, C. Li, X. Yang, H. Li, Journal of Polymer Science: Part A: Polymer Chemistry 2008, 46, 4857-4865, and in US 2005/0127329 A1.

A review of this field can also be found in N. Grossiord, J. Loos, O. Regev, C. E. Koning, Chem. Mater., 2006, 18 (5), 1089-1099.

Processes are also known from the literature (B. S. Shim, W. Chen, C. Doty, C. Xu, N. A. Kotov, Nano Lett. 2008, 8 (12), 4151-4157) in which cotton fibres are immersed in carbon nanotube dispersions based on ethanolic Nafion solution or aqueous PSS solution. This causes the carbon nanotubes to be adsorbed irreversibly on the surface of the fibres, forming a homogeneous coating and making these fibres electrically conductive.

B. Fugetsu et al. (Carbon 2008, ASAP, doi:10.1016/j.carbon.2008.11.013) established a process in which polyester fibres were passed through a dipping bath, causing their surface to be coated with CNTs. To this end multi-walled carbon nanotubes were first dispersed in aqueous solution by means of surfactants and then mixed with an anionic polyurethane dispersion. The temperature of the dipping bath was 40° C. The immersed fibres were then heated in an oven for 30 s to 170° C. (100° C. above the glass transition temperature of the polyester fibres). Depending on the concentration of nanotubes, even after being washed with water the fibres modified in this way exhibited electrical conductivity values in a range that is of interest for antistatic applications.

One possible alternative is the approach by which not the entire polymer matrix but only a layer of material directly adjacent to the surface is provided with particles. Such a procedure would be desirable as a means of avoiding the disadvantages described in the introduction of solvent consumption and the rise in viscosity.

A process is therefore proposed according to the invention for incorporating electrically conductive particles into a surface layer containing polyurethane, comprising the following steps:
(A) Preparing a solution of unaggregated carbon particles having an average particle diameter of ≧0.3 nm to ≦3000 nm in a solvent which is capable of causing the swelling of a surface layer containing polyurethane;
(B) Bringing the polyurethane-containing surface layer into contact with the solution of carbon particles;
(C) Causing the solution of carbon particles to act on the polyurethane-containing surface layer for a period of time which is not sufficient to convert the polyurethane into solution;
(D) Ending the action of the solution of carbon particles on the polyurethane-containing surface layer.

Electrically conductive particles within the meaning of the present invention are firstly all particles of a non-insulating material. Substances having an electrical conductivity of less than 10⁻⁸ S/m are typically described as insulating materials. The particles are incorporated into a polyurethane-containing surface layer, which means that it is not necessarily only the surface itself which is coated with the particles but that the material lying directly below the surface also absorbs the particles. Within the context of the invention the term surface layer, in contrast to the two-dimensional surface, thus also means a three-dimensional material layer which includes the surface as one of its boundaries. The surface layer is delimited on the inside of the object in question at least by the fact that it contains the electrically conductive particles.

The polyurethane (PU) itself can initially be any type of polyurethane and can contain the conventional additives such as fillers, flame retardants and the like. Examples of polyurethane classes are PU foams including foamed polyurethanes having a very high density of over 600 kg/m³, PU casting resins, PU casting elastomers and thermoplastic PU (TPU).

It is possible and preferable for the surface layer to belong to a polyurethane-containing moulding or to semi-finished products such as films, tubes or sheets. The polyurethane is thus generally not in the form of a polymer dispersion.

Step (A) comprises the provision of a solution of unaggregated carbon particles. This means that the particles are present in the solvent in separate form or at least that they are so slightly aggregated that the solution is stable. In a stable solution no flocculation or precipitation of the carbon particles occurs when it is stored at room temperature for a period of at least one day, preferably one week or four weeks. In order to prepare such a solution the existing aggregates of carbon particles can be broken up by the introduction of energy, for example by means of ultrasound, grinding processes or high shear forces. Finally the solvent is chosen on the basis that it can both form the solution of carbon particles and also cause the polyurethane surface to swell.

The average particle diameter can also be in a range from ≧1 nm to ≦1000 nm or from ≧3 nm to ≦100 nm. It can be determined by scanning electron microscopy or dynamic light scattering, for example.

The solvent can be an aqueous or a non-aqueous solvent. In the latter case it is preferably a polar, aprotic solvent. In this way the solvent can interact effectively with the soft segment domains in the polyurethane. The term “non-aqueous” means that no additional water was added to the solvent, but it does not exclude the technically unavoidable traces of water, for example up to an amount of ≦5 wt. %, preferably ≦3 wt. %, and more preferably ≦1 wt. %.

If the solvent is an aqueous solvent, the carbon particles can be deagglomerated by adding surfactants or other surface-active substances in solution and keeping them in solution.

The carbon particles can be present in the solvent in a concentration of for example ≧0.01 wt. % to ≦20 wt. %, ≧0.1 wt. % to ≦15 wt. % or ≧1 wt. % to ≦10 wt. %.

The bringing of the polyurethane-containing surface layer into contact with the solution of carbon particles in step (B) takes place naturally via the surface of the polyurethane.

In the subsequent step (C) the solution of carbon particles acts on the surface layer. Without being fixed on one theory, it is assumed that at least the soft segment domains in the polyurethane swell because of the solvent and form pores in the surface layer and that carbon particles can migrate into these pores. In aqueous or water-containing solvents the swelling of the soft segment domains is encouraged if there are long polyether segments in the polyurethane with a small number of carbon atoms between the ether bridges. Such domains are sufficiently hydrophilic to be able to swell. The particles can penetrate into the surface layer to a depth of ≦150 nm, ≦100 nm or ≦50 nm, for example.

In contrast to solvent-based processes, the exposure time is chosen such that the polyurethane in the surface layer is not converted into solution. Included herein are technically unavoidable solution processes in which for example ≦1 wt. %, ≦0.1 wt. % or ≦0.01 wt. % of the polyurethane passes into the solvent. The process according to the invention, however, is not one in which the polymer is first homogeneously dissolved and then the finished particles are obtained in the matrix together with nanoparticles by removing the solvent. Instead the exposure time is chosen such that a swelling of the polymer surface can take place. Examples of suitable exposure times are ≧1 minute to ≦360 minutes, preferably ≧10 minutes to ≦90 minutes, more preferably ≧3 minutes to ≦5 minutes.

Finally step (D) involves ending the action of the solution of carbon particles on the surface layer. The solution of carbon particles is thus separated from the surface layer again. Then the surface layer can be rinsed to remove adherent solution. This can be done for example by removing the polyurethane object with the surface layer to be modified from a dipping bath. The object can then be rinsed with acetone for example.

Step (D) is advantageously followed by a drying step in which the solvent present in the swollen surface layer is removed, wherein the pores in the polyurethane close and the carbon particles are enclosed in the polymer.

The process according to the invention thus offers the possibility of selectively providing the surface layer of a polyurethane object with electrically conductive particles. The shape of the object is not destroyed by dissolution, so even finished mouldings can be treated. As the particles are concentrated in the area of the object close to the surface, a relatively small amount is needed in total to obtain an electrically conductive polyurethane surface. Finally, in contrast to solution-based processes, there is no need to remove large amounts of solvents in order to obtain the finished, modified polymer. It is also possible to keep the concentration of carbon particles in a range in which no technically disadvantageous rise in viscosity occurs.

An advantageous application of the process according to the invention is the treatment of polyurethane mouldings which are subsequently to be painted by electrostatic powder coating or galvanised. The electrically conductive particles in the surface layer ensure an improved electrostatic powder application. A further application relates to the treatment of polyurethane mouldings in preparation for electrophoretic painting. Conductive electrode materials or flexible polyurethane capacitors can also be obtained. Furthermore, electronic components or cable sheaths can be provided with an antistatic coating.

In a preferred embodiment of the process according to the invention the action of the solution of carbon particles on the polyurethane-containing surface layer occurs with the use of ultrasound and/or heat. The introduction of energy by ultrasound and/or heat counteracts the formation of particle aggregates, thus allowing higher particle concentrations in the solution. The incorporation of the particles into the polyurethane surface layer is also accelerated. With ultrasound the frequency is advantageously ≧20 kHz to ≦20 MHz and independently thereof the power density in the solvent is ≧1 W/l to ≦200 W/l. If heating is introduced during the exposure period the temperature can be for example ≧30° C. to ≦200° C., preferably ≧40° C. to ≦150° C.

In a further embodiment of the process according to the invention the carbon particles are not covalently functionalised at their surface. This means that the particles carry no additional functional groups covalently bonded via additional reaction steps at their surface. In particular, the use of oxidising agents such as nitric acid, hydrogen peroxide, potassium permanganate and sulfuric acid or a possible mixture of these agents for the functionalisation of the carbon particles is avoided. An advantage of the use of non-covalently functionalised particles is that the π-electron system of the surface is not disrupted and can thus contribute without restriction to the electrical conductivity.

In a further embodiment of the process according to the invention the carbon particles are selected from the group comprising carbon nanotubes, single-walled carbon nanotubes, multi-walled carbon nanotubes, carbon nanohorns, carbon nano-onions, fullerene, graphite, graphene, carbon fibres and/or conductive carbon black. In addition to increasing the electrical conductivity, these particles can also improve mechanical properties of the surface layer, such as for example elasticity and impact resistance.

Carbon nanotubes within the meaning of the invention are all single-walled or multi-walled carbon nanotubes of the cylinder, scroll or multi-scroll type or having an onion-like structure. Multi-walled carbon nanotubes of the cylinder, scroll or multi-scroll type or mixtures thereof are preferably used. It is beneficial for the carbon nanotubes to have a ratio of length to external diameter of ≧5, preferably ≧100.

Unlike the known carbon nanotubes of the scroll type previously mentioned, which have only one continuous or discontinuous graphene layer, carbon nanotube structures also exist which consist of several graphene layers stacked together and rolled up. These are known as the multi-scroll type. These carbon nanotubes are described in DE 10 2007 044031 A1, to which reference is made in full. The way in which this structure relates to the carbon nanotubes of the single scroll type is comparable to the way in which the structure of multi-walled cylindrical carbon nanotubes (cylindrical MWNT) relates to the structure of single-walled cylindrical carbon nanotubes (cylindrical SWNT).

In contrast to the onion-type structures, when viewed in cross-section the individual graphene or graphite layers in these carbon nanotubes clearly run continuously from the centre of the carbon nanotubes to the outer edge without interruption This can allow a better and faster intercalation of other materials in the tube skeleton, for example, as there are more open edges available as entry zones for the intercalates as compared with carbon nanotubes having a single scroll structure (Carbon 1996, 34, 1301-3) or CNTs having an onion-type structure (Science 1994, 263, 1744-7).

In a preferred embodiment of the process according to the invention the carbon particles are non-covalently functionalised, multi-walled carbon nanotubes having a diameter of ≧3 nm to ≦100 nm. The diameter relates here to the average diameter of the nanotubes. It can also be in a range from ≧5 nm to ≦80 nm and advantageously from ≧6 nm to ≦60 nm. There is no initial limit to the length of the nanotubes. However, it can be in a range for example from ≧1 μm to ≦100 μm and advantageously from ≧10 μm to ≦30 μm.

In a further embodiment of the process according to the invention the polyurethane can be obtained from the reaction of polyisocyanates with polyester polyols and/or polyether polyols. Preferred polyisocyanates are those based on diphenylmethane diisocyanate (MDI) and toluene diisocyanate (TDI). Preferred polyester polyols and polyether polyols have hydroxyl values of ≧100 mg KOH/g to ≦150 mg KOH/g. Preferred polyols can furthermore have molar masses in the range from ≧250 to ≦5000 g/mol, preferably ≧400 to ≦3500 g/mol and a functionality between ≧1.8 and ≦6, preferably between ≧1.95 and ≦3.5. Included according to the invention are polyurethanes obtainable from prepolymers of the cited starting compounds with subsequent chain extension.

In a further embodiment of the process according to the invention the solvent is selected from the group comprising methanol, ethanol, isopropanol, butanol, ethylene glycol, propylene glycol, butylene glycol, glycerol, hydroquinone, acetone, ethyl acetate, trichloroethylene, trichloroethane, trichloromethane, methylene chloride, cyclohexanone, N,N-dimethylformamide, dimethyl sulfoxide, tetrahydrofuran, N-methyl-2-pyrrolidone, benzene, toluene, chlorobenzene, styrene, polyester polyols, polyether polyols, mixtures of the aforementioned solvents with one another and/or mixtures of the aforementioned solvents with water.

These solvents combine in a particular way the ability to form low-aggregate or aggregate-free solutions with the carbon particles and at the same time to lead to a swelling of the polyurethane surface. Mixtures of the aforementioned solvents apply to cases in which the solvent in the desired proportion is also soluble in water.

In a further embodiment of the process according to the invention the polyurethane-containing surface layer is brought into contact with the solution of carbon particles by dipping, spreading, printing, brushing, spraying and/or pouring. Complete objects for example can easily be treated by dipping in a dipping bath. A continuous process for producing a polymer film treated in this way can also easily be implemented. The printing of polyurethane objects, by screen printing for example, allows electrically conductive structures such as printed conductors to be produced on the polyurethane object.

In a further embodiment of the process according to the invention the polyurethane-containing surface layer is partially covered at least in step (C) by a mask. The mask covers certain areas of the surface and leaves other areas exposed. In this way electrically conductive structures, such as printed conductors and the like, can be produced on the elastomer surface. Another possible application for the use of a mask is to obtain insulating areas at the edges of a workpiece.

The present invention also provides a polyurethane layer containing electrically conductive carbon particles and obtainable by a process according to the invention wherein the outer surface of the polyurethane layer comprises bumps and indentations with an average height of the bumps of ≧50 nm to ≦500 nm and an average distance between adjacent bumps of ≧0.5 μm to ≦1.5 μm. The height of the bump is calculated from the vertical distance from the highest point of a bump to the lowest point of an adjacent indentation. In visual terms this distance corresponds to the distance from wave crest to wave trough. In visual terms the distance between adjacent bumps is then the distance between two wave crests. This can produce a frayed pattern in cross-section. The surface of the polyurethane layer can for example constitute a network of elongated bumps and the corresponding trough-shaped indentations. The average height of the bumps can also be in a range from ≧100 nm to ≦400 nm or from ≧150 nm to ≦300 nm. The average distance between adjacent bumps can also be in a range from ≧0.7 μm to ≦1.2 μm or from ≧0.9 μm to ≦1.0 μm.

The solution with the carbon particles causes the polyurethane segment structure to swell at the contact surface, which, depending on the polarity of the solution used, leads from a swelling of the soft segments through to a swelling of the rigid segments. In this way the carbon particles can interact with the polyurethane and penetrate into the polyurethane matrix. A subsequent evaporation of the solution thus leads through the embedding of the carbon particles to a changed morphology of the soft and rigid polyurethane segments at the surface. In the atomic force microscopy image this can be seen for example as wave-like bumps and indentations.

The polyurethane layer can have a specific resistance of for example ≧10⁻³ ohm cm to ≦10⁸ ohm cm. The specific resistance can be determined by reference to DIN IEC 60093(12).93. The specific resistance of this polyurethane layer is preferably in a range from ≧0.01 ohm cm to ≦1,000,000 ohm cm, particularly preferably ≧0.1 ohm cm to ≦100,000 ohm cm.

The present invention likewise relates to a polyurethane object having a surface layer containing electrically conductive carbon particles and obtainable by a process according to the invention, wherein the carbon particles are present in the polyurethane down to a depth of ≦1 μm below the surface. As already stated, the surface layer contains polyurethane. The particles in this surface layer advantageously form a network such that electrical conductivity occurs. The particles can also be positioned to a depth of ≦500 nm or ≦150 nm below the surface. Also included according to the invention are objects comprising the polyurethane surface layer provided with carbon particles and additionally also having further materials. They can for example be consumer objects comprising at least in part a polyurethane surface and wherein the electrically conductive carbon particles have been incorporated into this surface or polyurethane surface layer.

Polyurethane mouldings which are subsequently to be painted by electrostatic powder coating or by electrophoretic painting or which are to be galvanised can be cited by way of example of the aforementioned polyurethane objects. Other examples are conductive or conductive and flexible electrode materials, electronic components in general or cable sheaths having an antistatic coating.

In an embodiment of the polyurethane object the carbon particles within the polyurethane material of the surface layer containing them are present in a proportion of ≧0.1 wt. % to ≦5 wt. %. The proportion can also be in a range from ≧0.5 wt. % to ≦4 wt. % or from ≧1 wt. % to ≦5 wt. %. Ultimately the content of carbon particles in the surface layer is therefore indicated by this means. The limit of the surface layer inside the object, beyond which the polyurethane material no longer enters into the calculation, is formed by the lowest (innermost) line at which the carbon particles occur in the polyurethane. Within the specified ranges the percolation limit for the carbon particles is exceeded such that the electrical conductivity is dramatically improved.

In a further embodiment of the polyurethane object the surface layer containing the carbon particles has a specific resistance of ≧10⁻³ ohm cm to ≦10⁸ ohm cm. The specific resistance can be determined by reference to DIN IEC 60093(12).93. The specific resistance of this polyurethane layer is preferably in a range from ≧0.01 ohm cm to ≦1,000,000 ohm cm, particularly preferably ≧0.1 ohm cm to ≦100,000 ohm cm.

In a further embodiment of the polyurethane object the carbon particles are non-functionalised, multi-walled carbon nanotubes having a diameter of ≧3 nm to ≦100 nm. The diameter relates here to the average diameter of the nanotubes. It can also be in a range from ≧5 nm to ≦80 nm and advantageously from ≧6 nm to ≦60 nm. There is no initial limit to the length of the nanotubes. However, it can be in a range for example from ≧1 μm to ≦100 μm and advantageously from ≧10 μm to ≦30 μm.

In a further embodiment of the polyurethane object it has a first and a second surface layer containing electrically conductive carbon particles, wherein said first and second surface layer are positioned opposite one another and are separated from one another by a polyurethane layer. As a consequence of the production process the first and the second surface layers are integrally connected to the electrically insulating polyurethane layer which separates them. A flexible capacitor can be produced with such a structure of two electrically conductive layers separated by a dielectric.

In a further embodiment of the polyurethane object it takes the form of a composite of a support material with the polyurethane surface layer containing electrically conductive carbon particles. Examples of support materials are ceramics, metals and also other polymers such as polycarbonates or polyolefins. Thus for example a metal moulding can first be coated with polyurethane and then the polyurethane surface layer can be provided with the carbon particles.

The present invention is described in more detail by reference to the embodiment examples below in conjunction with the figures.

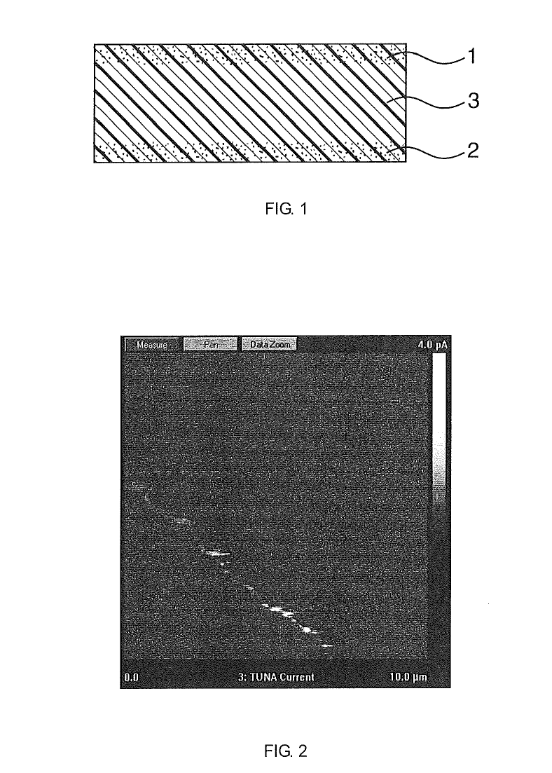

FIG. 1 shows a polyurethane object having a three-layer structure

FIG. 2 shows an atomic force microscopy image of the cross-section of a specimen

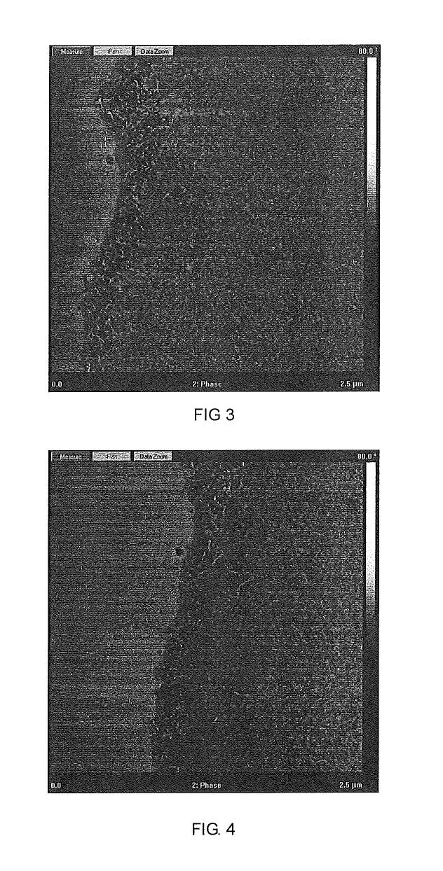

FIG. 3 shows another atomic force microscopy image of the cross-section of a specimen

FIG. 4 shows another atomic force microscopy image of the cross-section of a specimen

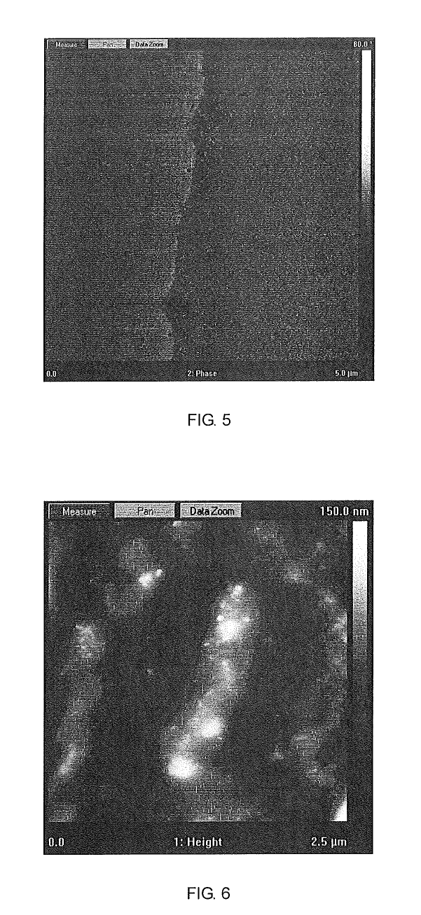

FIG. 5 shows another atomic force microscopy image of the cross-section of a specimen

FIG. 6 shows another atomic force microscopy image of the surface of a specimen

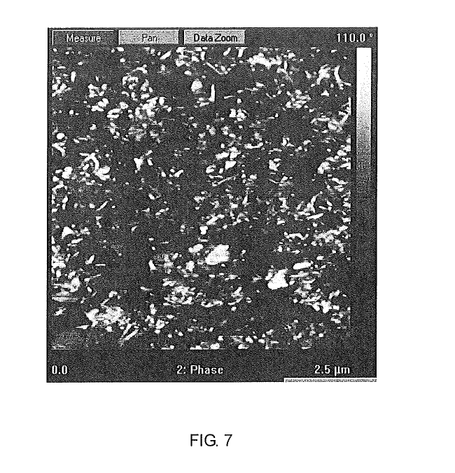

FIG. 7 shows another atomic force microscopy image of the surface of a specimen

### EMBODIMENT EXAMPLES

Materials Used, Polyurethane Production and General Method:
Polyol: Polyether polyol having an OH value of 112 mg KOH/mg and a viscosity of 140 mPa·s at 25° C.
Catalyst: Dibutyl tin dilaurate (0.02 wt. %), DABCO 33-LV® (0.54 wt. %, Air Products)
Isocyanate: DESMODUR® CD-S: modified isocyanate based on diphenylmethane-4,4′-diisocyanate having an NCO content of 29.0 to 30.0 wt. % and a viscosity of 20 to 50 mPa·s at 25° C.
Carbon particles: Multi-walled carbon nanotubes (BAYTUBES® C 150 P)
Dipping solution: Dispersion of BAYTUBES® C 150 P in a solvent

The cited polyol, catalyst and isocyanate components were mixed together at room temperature to give a characteristic value of 105. The dipping solution was produced by sonicating the carbon particles in an ultrasonic bath and was used immediately. In order to functionalise the polyurethane surface the specimens were completely immersed in the solution, briefly rinsed with acetone after being removed and freed from excess solvent at elevated temperature.

### Example 1

### (in NMP, with Ultrasound)

A test piece of a polyurethane elastomer (7×7×0.2 cm) was completely immersed in a solution of 1 wt. % BAYTUBES® C 150 P in N-methyl-2-pyrrolidone. The exposure time was 0.5 h with sonication in an ultrasonic bath and an additional 5.5 h without sonication at room temperature. The specimen was briefly rinsed with acetone and freed from solvents at 100° C. in a drying oven. The measured surface resistance was in the range from 10² to 10⁴ ohm cm. The integration of the nanotubes into the polyurethane surface down to a penetration depth of approximately 0.5 μm was able to be demonstrated by closer examination by AFM (FIG. 3). Corresponding conductivity measurements (TUNA) likewise demonstrated conductivity at the PU surface (FIG. 2).

### Example 2

### (in Acetone, with Ultrasound)

A test piece of a polyurethane elastomer (7×7×0.2 cm) was completely immersed in a solution of 0.5 wt. % BAYTUBES® C 150 P in acetone with sonication in an ultrasonic bath. The exposure time was 1 h, the temperature of the dipping solution was 45° C. The specimen was briefly rinsed with acetone and freed from solvent at 50° C. in a drying oven. The measured surface resistance was in the region of 10⁵ ohm cm.

### Example 3

### (in Acetone, without Ultrasound)

A test piece of a polyurethane elastomer (7×7×0.2 cm) was immersed in a solution of 0.5 wt. % BAYTUBES® C 150 P in acetone. The exposure time was 1 h, the temperature of the dipping solution was 23° C. The specimen was briefly rinsed with acetone and freed from solvent at 50° C. in a drying oven. The measured surface resistance was in the region of 10⁶ ohm cm.

FIG. 1 shows a schematic view of a polyurethane object according to the invention with a three-layer structure. Starting from a polyurethane workpiece carbon nanotubes were introduced into the upper (1) and the lower (2) surface layer of the polyurethane. These nanotubes are indicated by dashes or dots in the individual layers (1, 2). It can be seen that the nanotubes have a limited penetration depth in the surface layers. The surface layers are separated from one another by a polyurethane layer (3) which is free from nanotubes. Owing to the production process the polyurethane object still has a one-piece structure with regard to the surface layers (1, 2) and the surface layers are bonded to the nanotube-free layer (3). With appropriate dimensions the polyurethane object illustrated can be used as a film capacitor, for example.

A specimen of the polyurethane object obtained in Example 1 was examined by means of atomic force microscopy (AFM) images. Information about the presence and arrangement of the carbon nanotubes is provided by the tunnel AFM image in FIG. 2. This is a cross-section of the specimen. The width of the image section shown was 10 μm. In the left-hand part of the image is matrix material in which the specimen was encapsulated in order to prepare the cross-sections. In the right-hand part is the unchanged polyurethane material. Between them is the surface layer permeated by the tunnel current-conducting carbon nanotubes, which can be seen as bright dots.

FIGS. 3 and 4 show different image sections of the same specimen, viewed as a cross-section and in phase-sensitive mode. The width of the image section shown was 2.5 μm. In the left-hand part of the images is matrix material in which the specimen was encapsulated in order to prepare the cross-sections. In the right-hand part is the unchanged polyurethane material. Between them is the surface layer permeated by carbon nanotubes. In the phase-sensitive images in FIGS. 3 and 4 the carbon nanotubes embedded in the surface layer are clearly visible as bright lines. It can therefore be seen overall that the nanotubes are also present below the surface of the polyurethane.

FIG. 5 shows a further cross-sectional view with an image section width of 5 μm. The carbon nanotubes embedded in the surface layer can be seen as clearly visible bright lines.

FIGS. 6 and 7 show images of a top view of the surface of the specimen. The height image in FIG. 6 shows a structure featuring bumps and trough-shaped indentations. The width of the image section shown was 2.5 μm. In the corresponding phase-sensitive view in FIG. 7 carbon nanotubes accessible on the surface of the specimen can be seen as bright lines.

1-15. (canceled)

16. A process for incorporating electrically conductive particles into a surface layer comprising polyurethane, which comprises:
(A) preparing a solution of unaggregated carbon particles having an average particle diameter of from 0.3 nm to 3000 nm in a solvent which is capable of causing the swelling of a surface layer comprising polyurethane;
(B) bringing the polyurethane-containing surface layer into contact with the solution of carbon particles;
(C) causing the solution of carbon particles to act on the polyurethane-containing surface layer for a period of time which is not sufficient to convert the polyurethane into solution;
(D) ending the action of the solution of carbon particles on the polyurethane-containing surface layer.

17. The process according to claim 16, wherein the action of the solution of carbon particles on the polyurethane-containing surface layer occurs with the use of ultrasound and/or heat.

18. The process according to claim 16, wherein the carbon particles are not covalently functionalised at their surface.

19. The process according to claim 16, wherein the carbon particles are selected from the group consisting of carbon nanotubes, single-walled carbon nanotubes, multi-walled carbon nanotubes, carbon nanohorns, carbon nano-onions, fullerene, graphite, graphene, carbon fibres, conductive carbon black, and mixtures thereof.

20. The process according to claim 20, wherein the carbon particles comprise non-covalently functionalised, multi-walled carbon nanotubes having a diameter of from 3 nm to 100 nm.

21. The process according to claim 16, wherein the solvent is selected from the group consisting of methanol, ethanol, isopropanol, butanol, ethylene glycol, propylene glycol, butylene glycol, glycerol, hydroquinone, acetone, ethyl acetate, trichloroethylene, trichloroethane, trichloromethane, methylene chloride, cyclohexanone, N,N-dimethylformamide, dimethyl sulfoxide, tetrahydrofuran, N-methyl-2-pyrrolidone, benzene, toluene, chlorobenzene, styrene, polyester polyols, polyether polyols, mixtures thereof, and mixtures thereof with water.

22. The process according to claim 16, wherein the polyurethane-containing surface layer is brought into contact with the solution of carbon particles by dipping, spreading, printing, brushing, spraying and/or pouring.

23. The process according to claim 16, wherein the polyurethane-containing surface layer is partially covered at least in (C) by a mask.

24. A polyurethane layer comprising electrically conductive carbon particles obtained by the process according to claim 16, wherein an outer surface of the polyurethane layer comprises bumps and indentations with an average height of the bumps of from 50 nm to 500 nm and an average distance between adjacent bumps of from 0.5 μm to 1.5 μm.

25. A polyurethane object having a surface layer comprising electrically conductive carbon particles which is obtained by the process according to claim 16, wherein the carbon particles are present in the polyurethane object down to a depth of less than or equal to 1 μm below an outer surface of the polyurethane object.

26. The polyurethane object according to claim 25, wherein the electrically conductive carbon particles are present in a proportion of from 0.1 wt. % to 5 wt. %.

27. The polyurethane object according to claim 25, wherein the surface layer containing the electrically conductive carbon particles has a specific resistance of from 10⁻³ ohm cm to 10⁸ ohm cm at the surface.

28. The polyurethane object according to claim 25, wherein the electrically conductive carbon particles comprise non-covalently functionalised, multi-walled carbon nanotubes having a diameter of from 3 nm to 100 nm.

29. The polyurethane object according to claim 25, wherein the polyurethane object comprises a first surface layer and a second surface layer, both of which comprise electrically conductive carbon particles, wherein said first and second surface layers are positioned opposite one another and are separated from one another by a polyurethane layer.

30. The polyurethane object according to claim 25, wherein the polyurethane object is at least part of a composite of a support material.
